(19) United States
(12) Patent Application Publication
(10) Pub. No.: US 2005/0061558 A1
(43) Pub. Date: Mar. 24, 2005

(54) Tandem wheel assembly and mobile silvicultural apparatus including the same

(76) Inventors: Gino Jobin, Normandin (CA); David Potvin, Dolbeau-Mistassini (CA); Louis-Philippe Nault, Dolbeau-Mistassini (CA)

Correspondence Address: CENTRAL COAST PATENT AGENCY, PO BOX 187, AROMAS, CA, 95004, US

(21) Appl. No.: 10/840,890

(22) Filed: May 7, 2004

(30) Foreign Application Priority Data
May 8, 2003 (CA) 2,428,484

(51) Int. Cl. B62D 61/10

(52) U.S. Cl. 180/24.1

(57) ABSTRACT

A tandem wheel assembly including a support frame; a pair of wheels; a motor mounted onto the support frame for providing power to the wheels so as to impart a rotation of the wheels; and a power transmission system operatively connected between the motor and the wheels for transmitting power from the motor to the wheels. The power transmission system has a rotatable power transmission shaft including first and second components each having a longitudinal axis, the first and second components being connected to each other via coupling means for enabling the first and second components to rotate together as part of the rotatable power transmission shaft, while allowing the longitudinal axis of the second component to be displaced at an angle θ with respect to the longitudinal axis of the first component, so as to sustain a transversal load component subjected to the rotatable power transmission shaft.

### CROSS REFERENCE TO RELATED APPLICATIONS

The instant application hereby claims foreign priority benefits under Title 35, United States Code s119 to the Canadian patent application No. 2,428,484 filed on May 8^{th}, 2003.

### FIELD OF THE INVENTION

The present invention relates to an improved tandem wheel assembly. More particularly, the present invention relates to a tandem wheel assembly with an improved power transmission shaft and to a mobile silvicultural apparatus provided with such a tandem wheel assembly, generally a pair of such tandem wheel assemblies, the apparatus being used for carrying out various harvesting applications. The present tandem wheel assembly may be used on other types of apparatuses and vehicles, and in various other different fields, such as construction, mining, agriculture and the like.

### BACKGROUND OF THE INVENTION

Wheel assemblies, and in particular, wheel assemblies known as “tandem” wheel assemblies, because each wheel assembly generally comprises “a pair of” wheels, as well as the corresponding power transmission mechanisms used therewith, are well known in the art.

Indeed, these wheel assemblies may be used on various different types of vehicles and/or apparatuses and enable them to travel over uneven and/or rugged terrain for carrying out different applications, depending on the field for which they are intended.

FIG. 1 shows a typical example of a conventional tandem wheel assembly and corresponding power transmission mechanism. Such a conventional tandem wheel assembly is commercialized by a German company called NAF. This type of assembly is used widely on mobile silvicultural apparatuses employed for carrying out harvesting applications.

As shown, the tandem wheel assembly comprises a segment including gears 103 at the entrance (some gears have been omitted for sake of clarity), which are typically located at the center of the tandem. The gears 103 are generally mounted in a profiled recess which is sealed in an air-tight manner so as to enable the gears to continuously soak in lubrication means, such as an oil bath, for example. The gears, placed in series, enable to transmit the power coming from the transmission, for the propulsion of the vehicle, up to the wheels of said vehicle. In order to maximize the comfort of a user in the vehicle during the displacement thereof on a land to be worked, such as a forest, for example, the tandem is mounted on the frame of the vehicle by means of a large ball bearing enabling the tandem to rotate about its center.

As can be easily understood from FIG. 1, the transmittal of power coming from the transmission and being redirected towards the wheels is normally carried out as follows: a driving shaft 105 with universal joints originates from the exit of the transmission in order to get to the entrance of the central gear box, and a gear pair 107 transmits the power into the power transmission shafts 109 directed towards the gears 103 of the tandem.

It is also known in the art that the distance “L” between the supports of a power transmission shaft 109 is generally large. Indeed, the more a silvicultural apparatus is wide, the more this distance “L” becomes substantial.

A substantial problem associated with the above-mentioned type of tandem wheel assembly is that it is not intended to efficiently receive and cooperate with hydraulic motors for driving the mobile silvicultural apparatus. This is particularly true when the ground-clearing portion of a front unit of the apparatus is substantially high with respect to the ground on which the apparatus travels.

Tandem wheel assemblies with hydraulic motors are known in the art, and generally comprise a hydraulic motor mounted onto the tandem support frame, and being operatively connected to the wheels by means of a corresponding power transmission system for imparting motion to the wheels via a power transmission shaft. However, the conventional power transmission shaft is a single, rigid and elongated shaft, which during normal working conditions is subjected to substantial loads, particularly when there is a misalignment in certain components of the tandem wheel assembly (e.g. large central bearing) as a result of the apparatus travelling over rugged and/or uneven terrain. Consequently, the life span of such a power transmission shaft is fairly small, requiring considerable maintenance and/or replacement, which is costly and thus disadvantageous.

Known to the Applicant are the following US patents and patent applications which describe various wheel assemblies: U.S. Pat. Nos. 3,154,163; 3,349,863; 3,360,068; 3,471,166; 3,476,200; 3,481,418; 3,693,743; 3,810,516; 3,831,961; 4,222,578; 4,417,634; 4,647,067; 4,804,205; 4,824,418; 4,869,556; 5,191,952; 5,211,610; 5,339,611; 5,482,326; 5,911,286; 6,012,724; 6,193,007 B1; 6,625,967 B1; 6,698,478 B2; 2002/0092687 A1; and 2004/0060271 A1; as well as German patent application No. 3828332 A1.

However, none of these documents seem to teach a tandem wheel assembly which resolves the above-discussed problems, namely in regards to the use of a hydraulic motor within a restrained space (i.e. small distance “L”) or the short life span of the power transmission shaft 109.

Hence, in light of the aforementioned, there is a need for an improved tandem wheel assembly which, by virtue of its design and components, would be able to overcome some of the above-discussed prior art problems.

### SUMMARY OF THE INVENTION

The object of the present invention is to provide a tandem wheel assembly which satisfies some of the above-mentioned needs and which is thus an improvement over other related tandem wheel assemblies known in the prior art.

In accordance with the present invention, the above object is achieved, as will be easily understood, with a tandem wheel assembly for use with a mobile apparatus, the tandem wheel assembly comprising:
a support frame for mounting onto a base frame of the mobile apparatus;
a pair of wheels pivotally mounted onto the support frame;
a motor mounted onto the support frame for providing power to the wheels so as to impart a rotation of the wheels; and
a power transmission system operatively connected between the motor and the wheels for transmitting power from the motor to said wheels, the power transmission system comprising a rotatable power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft.

Preferably, the coupling means comprise:
a plurality of longitudinal splines provided about a peripheral outer surface of an end portion of the first component, the longitudinal splines extending in a direction substantially parallel to the longitudinal axis of the first component; and
a plurality of corresponding longitudinal slots provided about a peripheral inner surface of an end portion of the second component, the longitudinal slots extending in a direction substantially parallel to the longitudinal axis of the second component;
wherein the longitudinal splines of the first component are shaped and sized so as to be removably insertable into the corresponding longitudinal slots of the second component, so as to have the first and second components rotate together about their respective longitudinal axes while allowing the longitudinal axis of the second component to be displaced at an angle with respect to the longitudinal axis of the first component.

According to another aspect of the invention, there is also provided a mobile sylvicultural apparatus for travelling over a given terrain for carrying out harvesting work on said terrain, the mobile sylvicultural apparatus comprising:
a steerable wheeled base frame comprising a horizontally extending ground-clearing section, and first and second opposite vertical side sections;
harvesting means mounted to the steerable wheeled base frame for carrying out harvesting work on the terrain when the steerable wheeled support frame travels thereover;
at least one tandem wheel assembly for imparting motion to the steerable wheeled base frame, the least one tandem wheel assembly comprising:
   a support frame mounted onto the steerable wheeled base frame of the mobile sylvicultural apparatus;
   a pair of wheels pivotally mounted onto the support frame;
   a motor mounted onto the support frame for providing power to the wheels so as to impart a rotation of the wheels; and
   a power transmission system operatively connected between the motor and the wheels for transmitting power from the motor to said wheels, the power transmission system comprising a rotatable power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft; and
control means for controlling the steerable wheeled base frame, the harvesting means, and the at least one tandem wheel assembly.

According to another aspect of the invention, there is also provided a rotatable power transmission shaft pivotally mounted about supports of a corresponding power transmission system, the power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft.

The objects, advantages and other features of the present invention will become more apparent upon reading of the following non-restrictive description of a preferred embodiment thereof, given for the purpose of exemplification only, with reference to the accompanying drawings.

### BRIEF DESCRIPTION OF THE DRAWINGS

FIG. 1 is a top sectional view of a tandem wheel assembly and corresponding transmission mechanism according to the prior art.

FIG. 2 is a top sectional view of a tandem wheel assembly according to a first preferred embodiment of the present invention.

FIG. 3 is an exploded view of what is shown in FIG. 2, and better illustrating the first and second components of the power transmission shaft.

FIG. 4 is a side view of the first component of the power transmission shaft shown in FIG. 3.

FIG. 5 is a front plan view of what is shown in FIG. 4.

FIG. 6 is a rear plan view of what is shown in FIG. 4.

FIG. 7 is a side view of the second component of the power transmission shaft shown in FIG. 3.

FIG. 8 is a front plan view of what is shown in FIG. 7.

FIG. 9 is a side view of the abutment ring of the power transmission shaft shown in FIG. 3.

FIG. 10 is a front plan view of what is shown in FIG. 9.

FIG. 11 is a side view of the abutment ring of FIG. 9, and the second component of FIG. 7, assembled onto the first component of FIG. 4, so as to form the power transmission shaft of the tandem wheel assembly shown in FIG. 2.

FIG. 12 is a front plan view of what is shown in FIG. 11.

FIG. 13 is a rear plan view of what is shown in FIG. 11.

FIG. 14 is another side view of what is shown in FIG. 11, the second component being shown now displaced at an angle with respect to the first component.

FIG. 15 is a partial front plan view of a base frame of a mobile apparatus provided with a pair of tandem wheel assemblies according to the present invention.

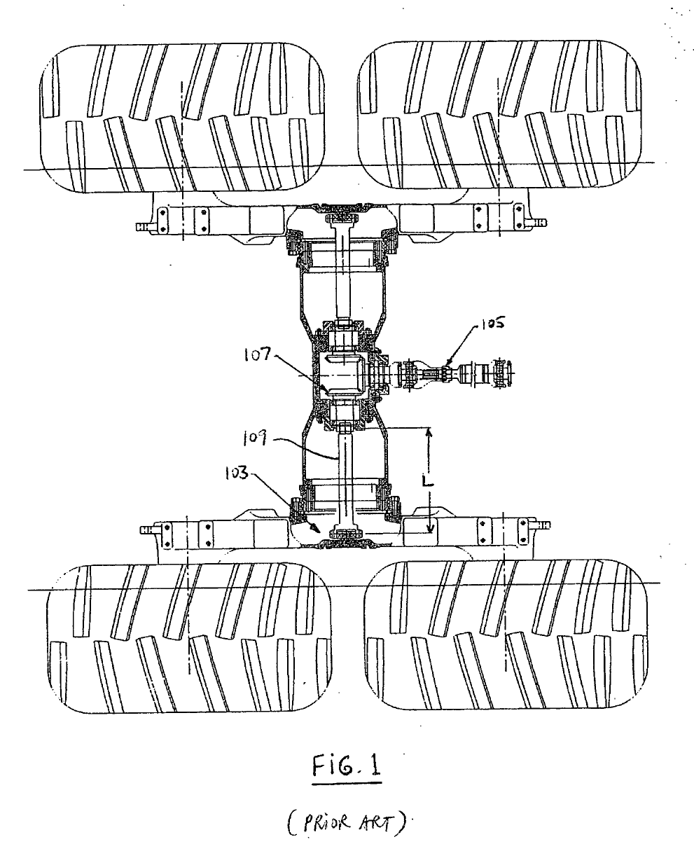

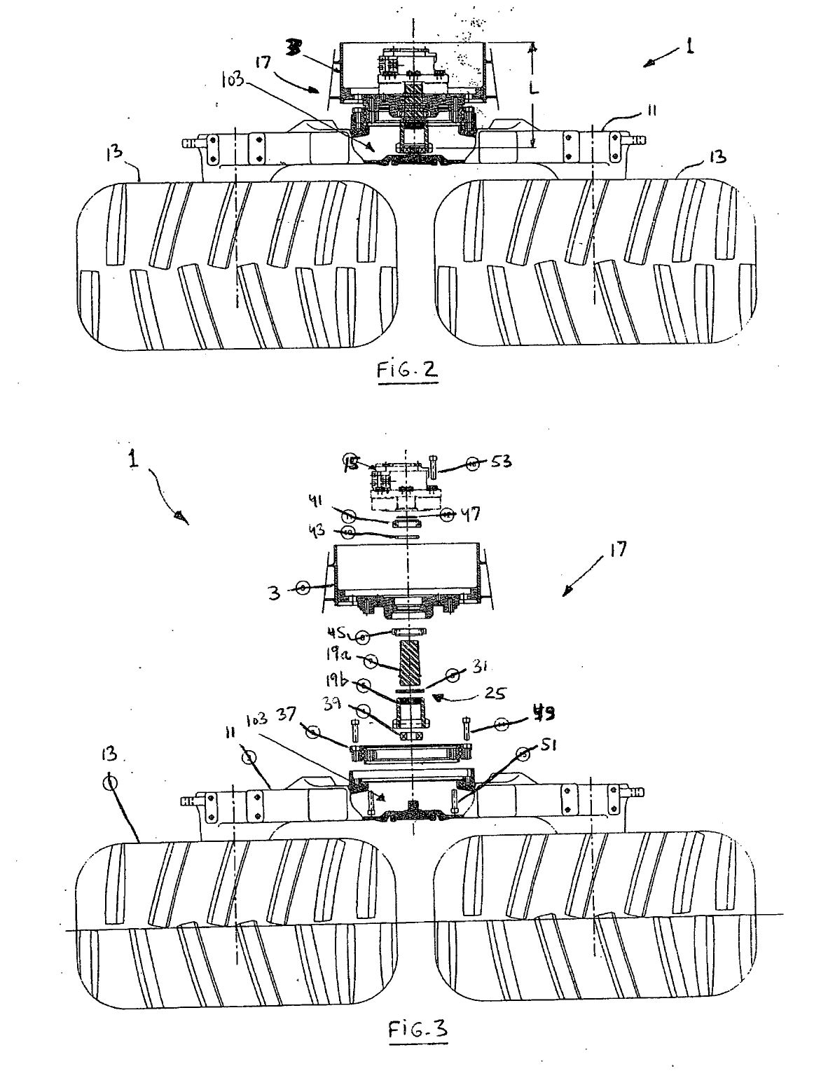

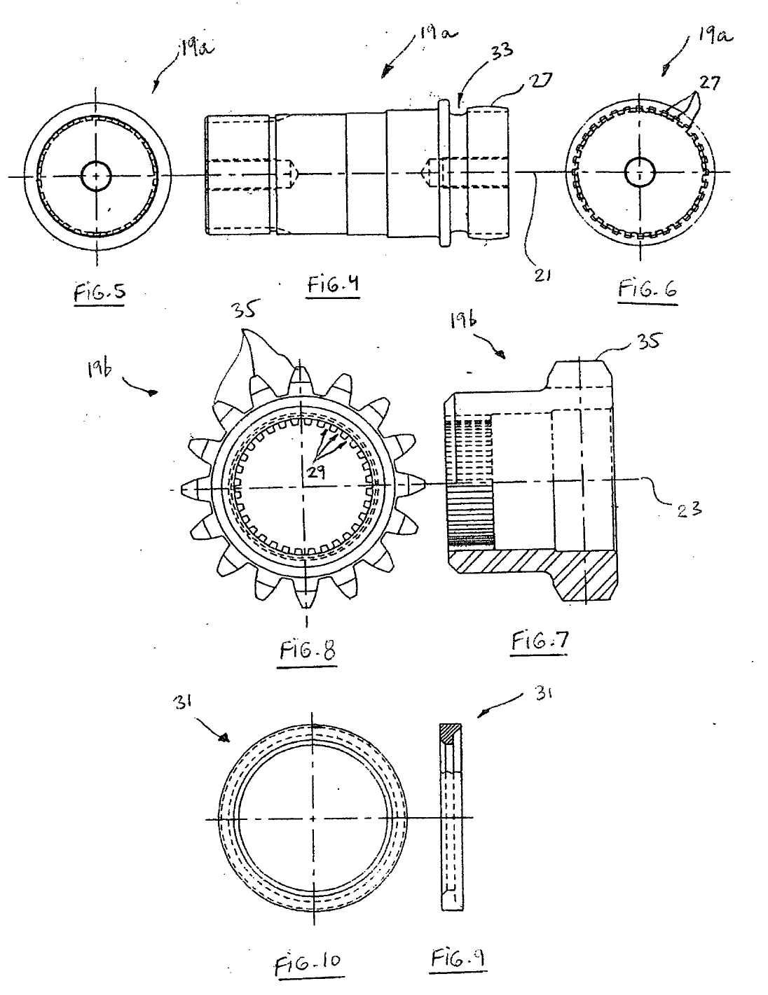

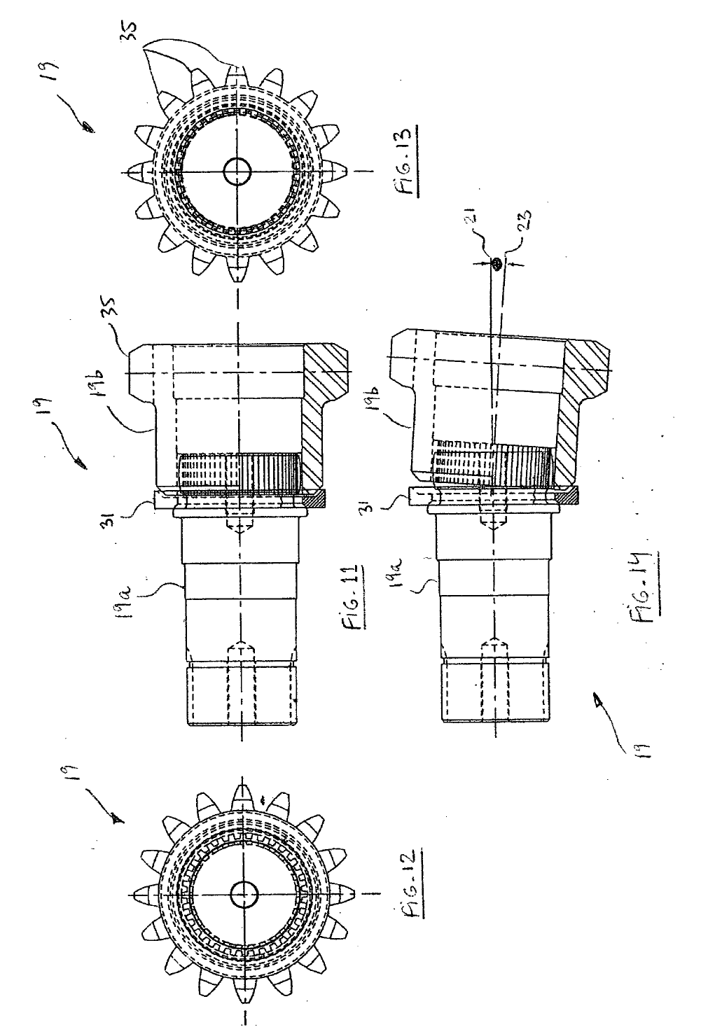

### DETAILED DESCRIPTION OF A PREFERRED EMBODIMENT OF THE INVENTION

In the following description, the same numerical references refer to similar elements. The embodiments shown in FIGS. 2-15 are preferred.

Moreover, although the present invention was primarily designed as a tandem wheel assembly for use with a mobile sylvicultural apparatus for harvesting applications and the like, it may be used on other types of wheel assemblies, having only one wheel for example, as well as on other types of apparatuses and vehicles, and in various other different fields, such as construction, mining, agriculture and the like, as apparent to a person skilled in the art. For this reason, expressions such as “tandem”, “sylvicultural”, “harvesting”, “trees”, “brush”, etc., used herein should not be taken as to limit the scope of the present invention and includes all other kinds of objects and/or applications with which the present invention could be used and may be useful. As will also be easily understood, the coupling means of the assembly 1 according to the present invention is not necessarily limited to crowned splines and slots, and may take on other suitable embodiments, as apparent to a person skilled in the art.

Moreover, in the context of the present invention, the expressions “tandem” and “wheel assembly”, as well as any other equivalent expressions and/or compound words thereof, may be used interchangeably. The same applies for any other mutually equivalent expressions, such as “tandem” and “support frame” for example, as well as “transmission shaft” and “driving shaft”, as also apparent to a person skilled in the art.

In addition, although the preferred embodiment of the present invention as illustrated in the accompanying drawings comprises various components such as bearings, sealing joints, rings, bolts, etc., and although the preferred embodiment of the tandem wheel assembly 1 and corresponding parts as shown consist of certain geometrical configurations as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperations thereinbetween, as well as other suitable geometrical configurations may be used for the tandem wheel assembly 1 and corresponding parts according to the present invention, as will be briefly explained herein and as can be easily inferred herefrom, without departing from the scope of the present invention.

Broadly described, the present invention, as illustrated in the accompanying drawings, relates to an improved tandem wheel assembly 1, and to a mobile apparatus provided with such an assembly 1. Typically, a mobile apparatus comprises a pair of such tandem wheel assemblies 1, generally one tandem wheel assembly 1 (each assembly 1 having preferably two wheels) on each side of a front unit of the apparatus, as can be easily understood when referring to FIGS. 2, 3 and 15.

According to the preferred embodiment of the present invention, the mobile apparatus is a mobile “sylvicultural” apparatus, such as the ones described in Applicant's U.S. Pat. Nos. 6,550,505 and 6,698,478, which are intended to carry out various types of “harvesting” applications, such as land clearing, for example, and the like, the content of these patents being incorporated herein by reference.

Indeed, broadly described, and as can be easily understood when referring to FIG. 15, the mobile sylvicultural apparatus according to the present invention is preferably used for travelling over a given terrain for carrying out harvesting work on said terrain, and preferably comprises a steerable wheeled base frame 3 comprising a horizontally extending ground-clearing section 5, and first and second opposite vertical side sections 7; harvesting means (or “manipulating” means—not shown) mounted to the steerable wheeled base frame 3 for carrying out harvesting work on the terrain when the steerable wheeled support frame 3 travels thereover; at least one tandem wheel assembly 1 for imparting motion to the steerable wheeled base frame 3; and control means (not shown) for controlling the steerable wheeled base frame, the harvesting means, and the at least one tandem wheel assembly 1.

According to the present invention, and as better shown in FIGS. 2 and 3, the tandem wheel assembly 1 comprises a support frame 11 (also referred to simply as “tandem”) for mounting onto the base frame 3 of the mobile apparatus; a pair of wheels 13 pivotally mounted onto the support frame 11 about a corresponding pivot axis; a motor 15 (preferably, an hydraulic motor 15) mounted onto the support frame 11 for providing power to the wheels 13 so as to impart a rotation to the wheels 13; and a power transmission system 17 operatively connected between the motor 15 and the wheels 13 for transmitting power from the motor 15 to said wheels 13. As shown in FIG. 3, and better illustrated in FIGS. 4-14, the power transmission system 17 comprises a rotatable power transmission shaft 19 having first and second components 19a, 19b, each having a longitudinal axis 21, 23, said first and second components 19a, 19b being connected to each other via coupling means 25 for enabling the first and second components 19a, 19b to rotate together as part of the rotatable power transmission shaft 19, while allowing the longitudinal axis 23 of the second component 19b (i.e. the second component 19b) to be displaced at an angle θ with respect to the longitudinal axis 21 of the first component 19a (i.e. the first component 19a), as better shown in FIG. 14, so as to be able to better sustain a transversal load component subjected to said rotatable power transmission shaft 19, as can be easily understood by a person skilled in the art.

Preferably, as better shown in FIGS. 4-8, and as can be easily understood when referring to FIGS. 11-14, the coupling means 25 comprise a plurality of longitudinal splines 27 provided about a peripheral outer surface of an end portion of the first component 19a, the longitudinal splines 27 extending in a direction substantially parallel to the longitudinal axis 21 of the first component 19a (see FIGS. 4-6); and a plurality of corresponding longitudinal slots 29 provided about a peripheral inner surface of an end portion of the second component 19b, the longitudinal slots 29 extending in a direction substantially parallel to the longitudinal axis 23 of the second component 19b (see FIGS. 7 and 8). The longitudinal splines 27 of the first component 19a are shaped and sized so as to be removably insertable into the corresponding longitudinal slots 29 of the second component 19b, so as to have the first and second components 19a, 19b rotate together about their respective longitudinal axes 21, 23 while allowing the longitudinal axis 23 of the second component 19b to be displaced at an angle θ with respect to the longitudinal axis 21 of the first component 19a, as can be easily understood when comparing FIGS. 11 and 14. The splines 27 and the slots 29 (defined by other neighboring splines, as can be easily understood) are preferably made by a suitable manufacturing process, such as machining for example, as apparent to a person skilled in the art.

Preferably also, the coupling means 25 comprise an abutment ring 31 mounted about a corresponding peripheral recess 33 of the first component 19a for abutting against the end portion of the second component 19b so as to delimit the positioning of the second component 19b with respect to the first component 19a, as can be easily understood when referring to FIGS. 4, 9 and 11. The inside bore of the abutment ring 31 preferably has tapered sections complementary to the end portions of the first and second components with which it cooperates, as better shown in FIGS. 9, 11 and 14.

Preferably also, the first and second components 19a, 19b are tubular components, and along with the abutment ring 31, and the other components of the tandem wheel assembly 1, are preferably made of suitable materials, and provided with suitable lubrication means, if need may be, as apparent to a person skilled in the art.

As better shown in FIGS. 4 and 5, the other end portion of the first component 19a is also preferably provided with a plurality of longitudinal splines provided about a peripheral outer surface of said another portion of the first component 19a, said longitudinal splines extending in a direction substantially parallel to the longitudinal axis 21 of the first component 19a and destined to cooperate with the motor 15, as apparent to a person skilled in the art.

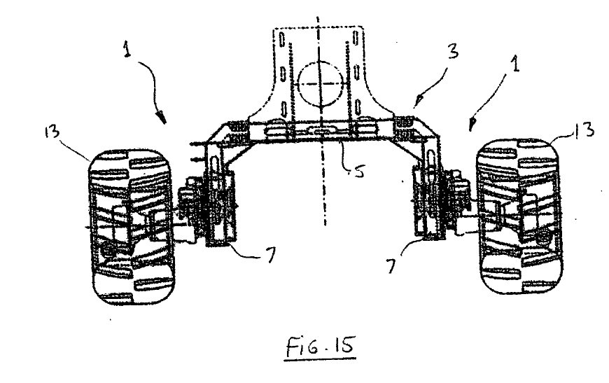

Preferably also, as can be easily understood when referring to FIGS. 7 and 13, the other end portion of the second component 19b is provided with a plurality of gear teeth 35 provided about a peripheral outer surface of said another portion of the second component 19b, for cooperating with the tandem support frame 11, as also apparent to a person skilled in the art.

The tandem wheel assembly 1 according to its preferred embodiment, as better shown in FIGS. 2 and 3, and as apparent to a person skilled in the art, preferably comprises the following components: a pair of tires or wheels 13; a tandem support frame 11; a securing bearing 37 of the tandem; a self-aligning bearing 39; a power transmission or driving shaft 19; a tapered roller bearing 41; a base frame of the vehicle; a sealing joint 43; a tapered roller bearing 45; a retaining ring 47; a hydraulic motor 15; a securing bolt 49 of the bearing on tandem; a securing bolt 51 of the bearing of the tandem on frame of vehicle; and a securing bolt 53 of the hydraulic motor 15 (some gears 103 in the tandem 11 have been omitted for sake of clarity).

As may now be better appreciated, the present invention is a substantial improvement over the prior art in that, as aforementioned, an important aspect of the present invention resides in the fact that instead of having a single, rigid and elongated transmission shaft as is the case with conventional tandem wheel assemblies, the tandem wheel assembly 1 according to the present invention comprises an improved transmission shaft 19 having at least two parts or components 19a, 19b, as better shown in FIGS. 3-14. The above-described coupling means 25 enable these two components 19a, 19b of the power transmission shaft 19 to be connected together and thus rotate in unison, as the transmission shaft 19 rotates, to carry out its normal driving function, while at the same time, enabling these two components 19a, 19b to be unaligned (i.e. displaced at an angle θ) with respect to each other, as better shown in FIG. 14, in order to have a “flexible zone” in the transmission shaft 19, and thus be able to better support loads and/or displacements to which the transmission shaft 19 of wheel assembly 1 may be subject to. Thus, the complementary crowned splines 27 and corresponding slots 29 offer a suitable flexibility to the power transmission shaft 19, i.e. enable to achieve a large misalignment between the first and second components 19a, 19b, within a more restrained space (smaller distance “L”—see FIG. 2), which is also very advantageous, particularly when using hydraulic motors 15 in tandem wheel assemblies 1.

It is worth mentioning once again that although the present invention was primarily intended for silvicultural applications, the present tandem wheel assembly 1, and the apparatus provided with such an assembly 1, may be used in other fields and for other applications, such as for mining applications, agricultural applications, and the like, as apparent to a person skilled in the art, without departing from the scope of the present invention. Furthermore, according to the present invention, the power transmission shaft 19 and corresponding first and second components 19a, 19b, with abutment ring 31, etc., such as the ones briefly described herein and such as the ones exemplified in the accompanying drawings, could be used as a power transmission shaft 19 in other types of wheels assemblies, such a single-wheel assemblies, as can be easily understood by a person skilled in the art. Further, as aforementioned, other suitable coupling means 25 for connecting the first and second components 19a, 19b, in the manner described herein, may be used according to the present invention, as apparent to a person skilled in the art.

Of course, numerous modifications could be made to the above-described embodiments without departing from the scope of the invention, as defined in the appended claims.

1. A tandem wheel assembly for use with a mobile apparatus, the tandem wheel assembly comprising:
a support frame for mounting onto a base frame of the mobile apparatus;
a pair of wheels pivotally mounted onto the support frame;
a motor mounted onto the support frame for providing power to the wheels so as to impart a rotation of the wheels; and
a power transmission system operatively connected between the motor and the wheels for transmitting power from the motor to said wheels, the power transmission system comprising a rotatable power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft.

2. A tandem wheel assembly according to claim 1, wherein the coupling means comprise:
a plurality of longitudinal splines provided about a peripheral outer surface of an end portion of the first component, the longitudinal splines extending in a direction substantially parallel to the longitudinal axis of the first component; and
a plurality of corresponding longitudinal slots provided about a peripheral inner surface of an end portion of the second component, the longitudinal slots extending in a direction substantially parallel to the longitudinal axis of the second component;
wherein the longitudinal splines of the first component are shaped and sized so as to be removably insertable into the corresponding longitudinal slots of the second component, so as to have the first and second components rotate together about their respective longitudinal axes while allowing the longitudinal axis of the second component to be displaced at an angle with respect to the longitudinal axis of the first component.

3. A tandem wheel assembly according to claim 2, wherein the coupling means comprise an abutment ring mounted about a corresponding peripheral recess of the first component for abutting against the end portion of the second component so as to delimit the positioning of the second component with respect to the first component.

4. A tandem wheel assembly according to claim 3, wherein the first and second components are tubular components.

5. A tandem wheel assembly according to claim 4, wherein another end portion of the first component is also provided with a plurality of longitudinal splines provided about a peripheral outer surface of said another portion of the first component, said longitudinal splines extending in a direction substantially parallel to the longitudinal axis of the first component and cooperating with the motor.

6. A tandem wheel assembly according to claim 5, wherein another end portion of the second component is provided with a plurality of gear teeth provided about a peripheral outer surface of said another portion of the second component, for cooperating with the support frame.

7. A tandem wheel assembly according to claim 6, wherein the motor is a hydraulic motor.

8. A mobile sylvicultural apparatus for travelling over a given terrain for carrying out harvesting work on said terrain, the mobile sylvicultural apparatus comprising:
a steerable wheeled base frame comprising a horizontally extending ground-clearing section, and first and second opposite vertical side sections;
harvesting means mounted to the steerable wheeled base frame for carrying out harvesting work on the terrain when the steerable wheeled support frame travels thereover;
at least one tandem wheel assembly for imparting motion to the steerable wheeled base frame, the least one tandem wheel assembly comprising:
a support frame mounted onto the steerable wheeled base frame of the mobile sylvicultural apparatus;
a pair of wheels pivotally mounted onto the support frame;
a motor mounted onto the support frame for providing power to the wheels so as to impart a rotation of the wheels; and
a power transmission system operatively connected between the motor and the wheels for transmitting power from the motor to said wheels, the power transmission system comprising a rotatable power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft; and
control means for controlling the steerable wheeled base frame, the harvesting means, and the at least one tandem wheel assembly.

9. A mobile sylvicultural apparatus according to claim 8, wherein the coupling means comprise:
a plurality of longitudinal splines provided about a peripheral outer surface of an end portion of the first component, the longitudinal splines extending in a direction substantially parallel to the longitudinal axis of the first component; and
a plurality of corresponding longitudinal slots provided about a peripheral inner surface of an end portion of the second component, the longitudinal slots extending in a direction substantially parallel to the longitudinal axis of the second component;
wherein the longitudinal splines of the first component are shaped and sized so as to be removably insertable into the corresponding longitudinal slots of the second component, so as to have the first and second components rotate together about their respective longitudinal axes while allowing the longitudinal axis of the second component to be displaced at an angle with respect to the longitudinal axis of the first component.

10. A mobile sylvicultural apparatus according to claim 9, wherein the coupling means comprise an abutment ring mounted about a corresponding peripheral recess of the first component for abutting against the end portion of the second component so as to delimit the positioning of the second component with respect to the first component.

11. A mobile sylvicultural apparatus according to claim 10, wherein the first and second components are tubular components

12. A mobile sylvicultural apparatus according to claim 11, wherein another end portion of the first component is also provided with a plurality of longitudinal splines provided about a peripheral outer surface of said another portion of the first component, said longitudinal splines extending in a direction substantially parallel to the longitudinal axis of the first component and cooperating with the motor.

13. A mobile sylvicultural apparatus according to claim 12, wherein another end portion of the second component is provided with a plurality of gear teeth provided about a peripheral outer surface of said another portion of the second component, for cooperating with the support frame.

14. A mobile sylvicultural apparatus according to claim 13, wherein the motor is a hydraulic motor.

15. A mobile sylvicultural apparatus according to claim 14, wherein another end portion of the first component is also provided with a plurality of longitudinal splines provided about a peripheral outer surface of said another portion of the first component, said longitudinal splines extending in a direction substantially parallel to the longitudinal axis of the first component and cooperating with the motor.

16. A mobile sylvicultural apparatus according to claim 15, wherein another end portion of the second component is provided with a plurality of gear teeth provided about a peripheral outer surface of said another portion of the second component, for cooperating with the support frame.

17. A mobile sylvicultural apparatus according to claim 16, wherein the motor is a hydraulic motor.

18. A mobile sylvicultural apparatus according to claim 17, wherein the at least one tandem wheel assembly comprises a pair of tandem wheel assemblies, one on either side of a front unit of the apparatus.

19. A rotatable power transmission shaft pivotally mounted about supports of a corresponding power transmission system, the power transmission shaft having first and second components each having a longitudinal axis, said first and second components being connected to each other via coupling means for enabling the first and second components to rotate together as part of the rotatable power transmission shaft, while allowing the longitudinal axis of the second component to be displaced at an angle with respect to the longitudinal axis of the first component, so as to sustain a transversal load component subjected to said rotatable power transmission shaft.

20. A rotatable power transmission shaft according to claim 19, wherein wherein the coupling means comprise:
a plurality of longitudinal splines provided about a peripheral outer surface of an end portion of the first component, the longitudinal splines extending in a direction substantially parallel to the longitudinal axis of the first component; and
a plurality of corresponding longitudinal slots provided about a peripheral inner surface of an end portion of the second component, the longitudinal slots extending in a direction substantially parallel to the longitudinal axis of the second component;
wherein the longitudinal splines of the first component are shaped and sized so as to be removably insertable into the corresponding longitudinal slots of the second component, so as to have the first and second components rotate together about their respective longitudinal axes while allowing the longitudinal axis of the second component to be displaced at an angle with respect to the longitudinal axis of the first component.
